(19) United States
(12) Patent Application Publication
(10) Pub. No.: US 2025/0365097 A1
(43) Pub. Date: Nov. 27, 2025

(54) COMPRESSION BASED ENCODING FOR NONUNIFORM MESSAGE TRANSMISSION

(71) Applicant: QUALCOMM Incorporated, San Diego, CA (US)

(72) Inventors: Pinar SEN, San Diego, CA (US); Wei YANG, San Diego, CA (US); Jing JIANG, San Diego, CA (US)

(21) Appl. No.: 18/674,726

(22) Filed: May 24, 2024

(51) Int. Cl. H04L 1/1812; H04L 1/1607

(52) U.S. Cl. CPC H04L 1/1812; H04L 1/1607

(57) ABSTRACT

Methods, systems, and devices for wireless communications are described. Techniques described herein provide for compression based encoding for nonuniform message transmission. In some examples, a user equipment (UE) may generate a first candidate codeword that is one of a first set of candidate codewords. The UE may select, based on the first candidate codeword, a first selected codeword from a second set of codewords in a codebook. The second set of codewords may include a representative codeword that maps to more than one of the first set of candidate codewords, and remaining codewords other than the representative codeword of the second set of codewords may be each mapped to a respective one of the first set of candidate codewords. The UE may transmit the first selected codeword.

### FIELD OF TECHNOLOGY

The following relates to wireless communications, including compression based encoding for nonuniform message transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include generating a first candidate codeword that is one of a first set of candidate codewords, selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords, and transmitting the first selected codeword.

A UE for wireless communications is described. The UE may include one or more memories storing processor executable code, and one or more processors coupled with the one or more memories. The one or more processors may individually or collectively be operable to execute the code to cause the UE to generate a first candidate codeword that is one of a first set of candidate codewords, select, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords, and transmit the first selected codeword.

Another UE for wireless communications is described. The UE may include means for generating a first candidate codeword that is one of a first set of candidate codewords, means for selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords, and means for transmitting the first selected codeword.

A non-transitory computer-readable medium storing code for wireless communications is described. The code may include instructions executable by one or more processors to generate a first candidate codeword that is one of a first set of candidate codewords, select, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords, and transmit the first selected codeword.

In some examples of the method, user equipment (UEs), and non-transitory computer-readable medium described herein, the more than one of the first set of candidate codewords map to the representative codeword of the second set of codewords based on each of the more than one of the first set of candidate codewords satisfying a threshold.

In some examples of the method, user equipment (UEs), and non-transitory computer-readable medium described herein, the threshold may be a quantity of hybrid-automatic repeat request (HARQ) negative acknowledgment (NACK) bit values and the first set of candidate codewords each represent a unique combination of HARQ bit values.

In some examples of the method, user equipment (UEs), and non-transitory computer-readable medium described herein, the threshold may be a quantity of zero bit values and the first set of candidate codewords each represent a unique combination of bit values.

In some examples of the method, user equipment (UEs), and non-transitory computer-readable medium described herein, satisfaction of the threshold may be not based on dummy bits included in any of the first set of candidate codewords.

In some examples of the method, user equipment (UEs), and non-transitory computer-readable medium described herein, the threshold may be associated with a codeword length of each of the first set of candidate codewords.

Some examples of the method, user equipment (UEs), and non-transitory computer-readable medium described herein may further include operations, features, means, or instructions for receiving control signaling that indicates the threshold.

In some examples of the method, user equipment (UEs), and non-transitory computer-readable medium described herein, each of the second set of codewords corresponds to a same quantity of message bits as each of the first set of candidate codewords.

In some examples of the method, user equipment (UEs), and non-transitory computer-readable medium described herein, a probability of generation of individual ones of the first set of candidate codewords may be non-uniform.

In some examples of the method, user equipment (UEs), and non-transitory computer-readable medium described herein, the more than one of the first set of candidate codewords that map to the representative codeword may have respective first probabilities of generation that may be less than second probabilities of generation that correspond to the respective ones of the first set of candidate codewords that map to the remaining codewords.

In some examples of the method, user equipment (UEs), and non-transitory computer-readable medium described herein, the second set of codewords may be a subset of the first set of candidate codewords.

In some examples of the method, user equipment (UEs), and non-transitory computer-readable medium described herein, transmitting the first selected codeword may include operations, features, means, or instructions for modifying a transmit power based on a first quantity of codewords in the second set of codewords, where the first quantity of codewords may be based on a second quantity of the more than one of the first set of candidate codewords that satisfy a threshold and transmitting the first selected codeword based on the modified transmit power.

In some examples of the method, user equipment (UEs), and non-transitory computer-readable medium described herein, transmitting the first selected codeword may include operations, features, means, or instructions for multiplexing the first selected codeword with non-compressed uplink control information and transmitting the multiplexed first selected codeword.

In some examples of the method, user equipment (UEs), and non-transitory computer-readable medium described herein, transmitting the multiplexed first selected codeword may include operations, features, means, or instructions for modifying a transmit power based on a first quantity of non-compressed uplink control information codewords and a second quantity of codewords in the second set of codewords, where the second quantity of codewords may be based on a third quantity of the more than one of the first set of candidate codewords that satisfy a threshold and transmitting the multiplexed first selected codeword based on the modified transmit power.

A method for wireless communications by a network entity is described. The method may include outputting, to a UE, control signaling that indicates a threshold and obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

A network entity for wireless communications is described. The network entity may include one or more memories storing processor executable code, and one or more processors coupled with the one or more memories. The one or more processors may individually or collectively be operable to execute the code to cause the network entity to output, to a UE, control signaling that indicates a threshold and obtain a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

Another network entity for wireless communications is described. The network entity may include means for outputting, to a UE, control signaling that indicates a threshold and means for obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

A non-transitory computer-readable medium storing code for wireless communications is described. The code may include instructions executable by one or more processors to output, to a UE, control signaling that indicates a threshold and obtain a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

In some examples of the method, network entities, and non-transitory computer-readable medium described herein, the threshold may be a quantity of HARQ NACK bit values and the first set of candidate codewords each represent a unique combination of HARQ bit values.

In some examples of the method, network entities, and non-transitory computer-readable medium described herein, the threshold may be a quantity of zero bit values and the first set of candidate codewords each represent a unique combination of bit values.

In some examples of the method, network entities, and non-transitory computer-readable medium described herein, satisfaction of the threshold may be not based on dummy bits included in any of the first set of candidate codewords.

In some examples of the method, network entities, and non-transitory computer-readable medium described herein, the threshold may be associated with a codeword length of each of the first set of candidate codewords.

In some examples of the method, network entities, and non-transitory computer-readable medium described herein, each of the second set of codewords corresponds to a same quantity of message bits as each of the first set of candidate codewords.

In some examples of the method, network entities, and non-transitory computer-readable medium described herein, a probability of generation of individual ones of the first set of candidate codewords may be a non-uniform.

In some examples of the method, network entities, and non-transitory computer-readable medium described herein, the more than one of the first set of candidate codewords that map to the representative codeword may have respective first probabilities of generation that may be less than second probabilities of generation that correspond to the respective ones of the first set of candidate codewords that map to the remaining codewords.

In some examples of the method, network entities, and non-transitory computer-readable medium described herein, the second set of codewords may be a subset of the first set of candidate codewords.

In some examples of the method, network entities, and non-transitory computer-readable medium described herein, the first selected codeword may be multiplexed with non-compressed uplink control information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports compression based encoding for nonuniform message transmission in accordance with one or more aspects of the present disclosure.

FIG. 2 shows an example of a wireless communications system that supports compression based encoding for nonuniform message transmission in accordance with one or more aspects of the present disclosure.

FIG. 3 shows an example of a codeword diagram that supports compression based encoding for nonuniform message transmission in accordance with one or more aspects of the present disclosure.

FIG. 4 shows an example of a process flow that supports compression based encoding for nonuniform message transmission in accordance with one or more aspects of the present disclosure.

FIGS. 5 and 6 show block diagrams of devices that support compression based encoding for nonuniform message transmission in accordance with one or more aspects of the present disclosure.

FIG. 7 shows a block diagram of a communications manager that supports compression based encoding for nonuniform message transmission in accordance with one or more aspects of the present disclosure.

FIG. 8 shows a diagram of a system including a device that supports compression based encoding for nonuniform message transmission in accordance with one or more aspects of the present disclosure.

FIGS. 9 and 10 show block diagrams of devices that support compression based encoding for nonuniform message transmission in accordance with one or more aspects of the present disclosure.

FIG. 11 shows a block diagram of a communications manager that supports compression based encoding for nonuniform message transmission in accordance with one or more aspects of the present disclosure.

FIG. 12 shows a diagram of a system including a device that supports compression based encoding for nonuniform message transmission in accordance with one or more aspects of the present disclosure.

FIGS. 13 through 15 show flowcharts illustrating methods that support compression based encoding for nonuniform message transmission in accordance with one or more aspects of the present disclosure.

### DETAILED DESCRIPTION

A user equipment (UE) may receive downlink signaling from a network entity, and the UE may transmit feedback messages for the downlink signaling. For example, the UE may transmit a feedback codebook, such as a hybrid-automatic repeat request (HARQ) acknowledgment (ACK) or negative acknowledgment (NACK) codebook including feedback bits indicating ACK or NACK information for the scheduled downlink signaling. In some examples, the UE may be more likely to transmit the ACK (e.g., bit value 1) than the NACK (e.g., bit value 0). For example, the HARQ feedback message at a 10% block-error rate (BLER) in physical downlink shared channel (PDSCH) may comprise a non-uniform probability of 90% ACK and 10% NACK. However, current codebooks are designed for uniform probability of messages with equal likelihood of the bit value 0 and bit value 1. There is a desire for compression based encoding for non-uniform message transmission (for both HARQ feedback messages as well as other messages with a non-uniform content inclusion probability).

A non-uniform message, as used herein, includes codewords where a probability of generation of individual ones of candidate codewords is non-uniform. In order to more efficiently compress these non-uniform messages, a UE may generate a codeword for inclusion in a message and then may access a listing of candidate codewords to determine which of the candidate codewords is representative of the generated codeword. The list of candidate codewords includes fewer codewords than are possible for the UE to generate. One of the candidate codewords is representative of multiple possible generated codewords. The multiple possible generated codewords are each associated with a probability of generation that is relatively low. As such, a single candidate codeword represents each of these “low probability” codewords. Other, higher probability codewords in the list of candidate codewords have a one-to-one relationship with generated codewords. Therefore, the list of candidate codewords is a compressed list.

Techniques for a compressed codebook may be employed for encoding non-uniform message transmission. For example, multiple codewords may be combined into a single codeword. In some examples, a UE may generate a first candidate codeword that is one of a first set of candidate codewords. The UE may select, based on the first candidate codeword, a first selected codeword from a second set of codewords in a codebook. The second set of codewords may include a representative codeword that maps to more than one of the first set of candidate codewords, and remaining codewords other than the representative codeword of the second set of codewords are each mapped to a respective one of the first set of candidate codewords. The UE may transmit the first selected codeword. In some cases, the more than one of the first set of candidate codewords may map to the representative codeword of the second set of codewords based on each of the more than one of the first set of candidate codewords satisfying a threshold. In some examples, the threshold may be associated with a quantity of HARQ NACK bit values, and the first set of candidate codewords may each represent a unique combination of HARQ bit values. In some cases, the UE may receive control signaling indicating the threshold.

Aspects of the disclosure are initially described in the context of wireless communications systems. Aspects of the disclosure are also described in context of a codeword diagram and a process flow. Aspects of the disclosure are further illustrated by and described with reference to apparatus diagrams, system diagrams, and flowcharts that relate to compression based encoding for nonuniform message transmission.

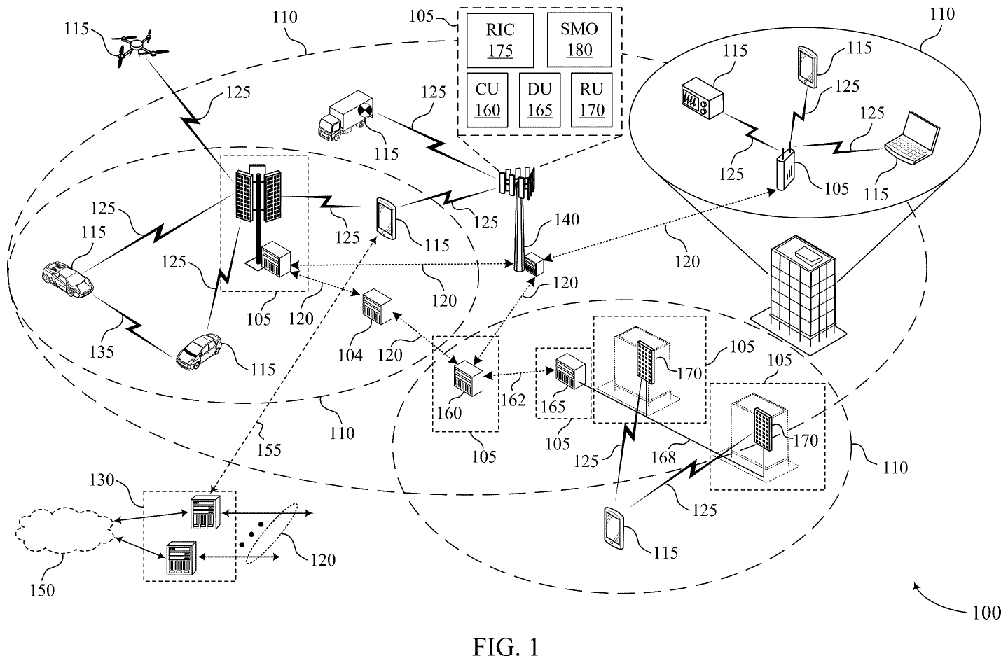

FIG. 1 shows an example of a wireless communications system 100 that supports compression based encoding for nonuniform message transmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive downlink signaling from a network entity 105, and the UE 115 may transmit feedback messages for the downlink signaling. For example, the UE 115 may transmit a feedback codebook, such as a HARQ ACK or NACK codebook including feedback bits indicating ACK or NACK information for the scheduled downlink signaling. In some examples, the UE 115 may be more likely to transmit the ACK (e.g., bit value 1) than the NACK (e.g., bit value 0). For example, the HARQ feedback message at a 10% BLER in PDSCH may comprise a non-uniform probability of 90% ACK and 10% NACK. However, current codebooks are designed for uniform probability of messages with equal likelihood of the bit value 0 and bit value 1. There is a desire for compression based encoding for non-uniform message transmission.

Techniques for compressed codebook may be employed for encoding non-uniform message transmission. For example, multiple codewords may be combined into a single codeword. In some examples, a UE 115 may generate a first candidate codeword that is one of a first set of candidate codewords. The UE 115 may select, based on the first candidate codeword, a first selected codeword from a second set of codewords in a codebook. The second set of codewords may include a representative codeword that maps to more than one of the first set of candidate codeword, and remaining codewords other than the representative codeword of the second set of codewords are each mapped to a respective one of the first set of candidate codewords. The UE 115 may transmit the first selected codeword. In some cases, the more than one of the first set of candidate codewords may map to the representative codeword of the second set of codewords based on each of the more than one of the first set of candidate codewords satisfying a threshold. In some examples, the threshold may be associated with a quantity of HARQ NACK bit values, and the first set of candidate codewords may each represent a unique combination of HARQ bit values. In some cases, the UE 115 may receive control signaling indicating the threshold.

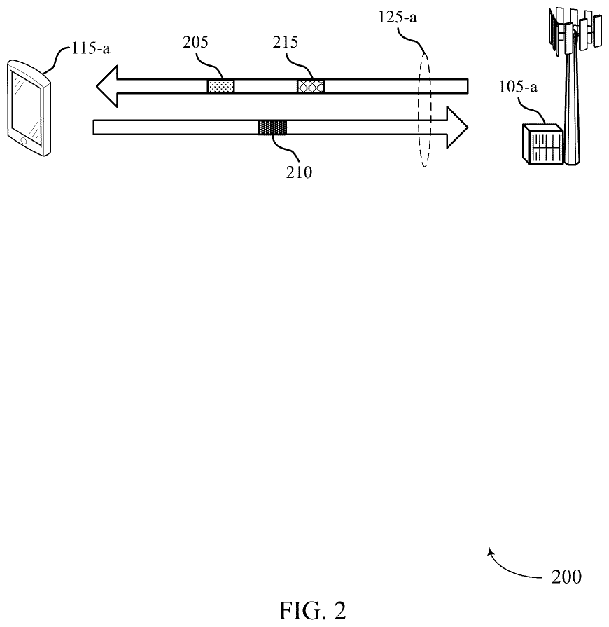

FIG. 2 shows an example of a wireless communications system 200 that supports compression based encoding for nonuniform message transmission in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the network entity 105-a may transmit downlink signals (e.g., downlink transmissions), such as downlink control signaling and downlink data signals, to the UE 115-a using the communication link 125-a, and the UE 115-a may transmit uplink signals (e.g., uplink transmissions), including uplink control signaling and uplink data signals to the network entity 105-a using the communication link 125-a.

In some examples, the UE 115-a may receive a downlink message 205 from the network entity 105-a, and the UE 115-a may transmit a message 210 providing feedback for the downlink message 205. For example, the UE 115-a may transmit a feedback codebook, such as a HARQ ACK or NACK codebook including feedback bits indicating ACK or NACK information for scheduled downlink messages (e.g., PDSCH transmissions). In some examples, the UE 115-a may be more likely to transmit the ACK (e.g., bit 1) than the NACK (e.g., bit 0). For example, the network entity 105-a may schedule five messages on the PDSCH, and the UE 115-a may transmit a five bit message for HARQ ACK/NACK based on the decoding of the PDSCH transmissions. At a 10% BLER in PDSCH, the UE 115-a may transmit 90% ACK and 10% NACK or ACK (e.g., bit 1) with a 90% probability and NACK (e.g., bit 0) with a 10% probability. However, current codebooks are designed for uniform probability of messages with equal likelihood of the bit 0 and bit 1. There is a desire for compression based encoding for non-uniform message transmission.

In some examples, the UE 115-a may implement a compression procedure on the message 210 prior to transmitting the message 210 to the network entity 105-a. The compressed and encoded message may be transmitted as codewords. For the compression, the UE 115-a may transmit a subcode of a larger code where the compressed message may be mapped to a smaller quantity of codewords. In some cases, K bits of the message may be compressed in to K′ bits using fixed-to-fixed lossy compression, and the UE 115-a may encode the compressed K′ bits using a (K′, N) encoder. For example, the uncompressed message may be non-uniform with an ACK (e.g., bit 1) with a 90% probability and NACK (e.g., bit 0) with a 10% probability with K=4 (e.g., 1111, 1110, 1101, 1011, 0111, 0011, 0101, 1001, 0110, 1010, 1100, 0001, 0010, 0100, 1000, 0000). For K′=3, the compressed message may be 111, 110, 101, 100, 011, 010, 001, 000 with 1111 mapping to 111, 1110 mapping to 110, 1101 mapping to 101, 1011 mapping to 100, 0111 mapping to 011, 0011 mapping to 010, 0101 mapping to 001, and 1001 0110, 1010, 1100, 0001, 0010, 0100, 1000, 0000 mapping to 000. The compressed message may be encoded with NR Reed Muller codewords (N=32).

In some examples, the compression and encoding of the HARQ-ACK message may have some problems. In some cases, for HARQ-ACK codebook (e.g., type 1 or type 2 in 5G), the UE 115-a may insert dummy HARQ-ACK bits to the HARQ-ACK codebook that may interleave the actual payload. The purpose of the dummy bits may be to align the HARQ-ACK codebook size or format between the UE 115-a and network entity 105-a. For type-1 HARQ-ACK codebook, the size of the codebook is fixed and independent from the actual quantity of HARQ-ACK bits the UE 115-a may transmit. The UE 115-a may insert the actual HARQ-ACK bits to the corresponding location of the codebook and may leave the rest as dummy bits (e.g., zero bits). For example, a₀, a₁, a₂, a₃, a₄, a₅ may be an example codebook, with a₂ and a₅ being actual HARQ-ACK bits and a₀, a₁, a₃, and a₄ being dummy HARQ-ACK bits. In some cases, the UE 115-a and network entity 105-a may have different understandings about the location or value of some dummy bits, but the existing HARQ-ACK codebook design may guarantee that for the locations where UE 115-a and network entity 105-a have the same understanding, the receiving device may be able to decode correctly (e.g., when channel condition is good). For the case with the dummy bits, when compression changes K bits to K′ bits and there is a missed grant, the UE 115-a and the network entity 105-a may have a problem of not agreeing which K′ bits out of the K bits are chosen by the UE during the compression. In some examples, another problem with the compression of HARQ-ACK may be the K′ quantity of bits being rounded to the nearest integer. For example, if there are 9 most likely messages, 4 bits may be used to transmit the 9 message. A further problem for the compression of HARQ-ACK may be an additional complexity on the transmission and reception side to implement the compression by relabeling the more likely message from K bit labeling to K′ bit labeling.

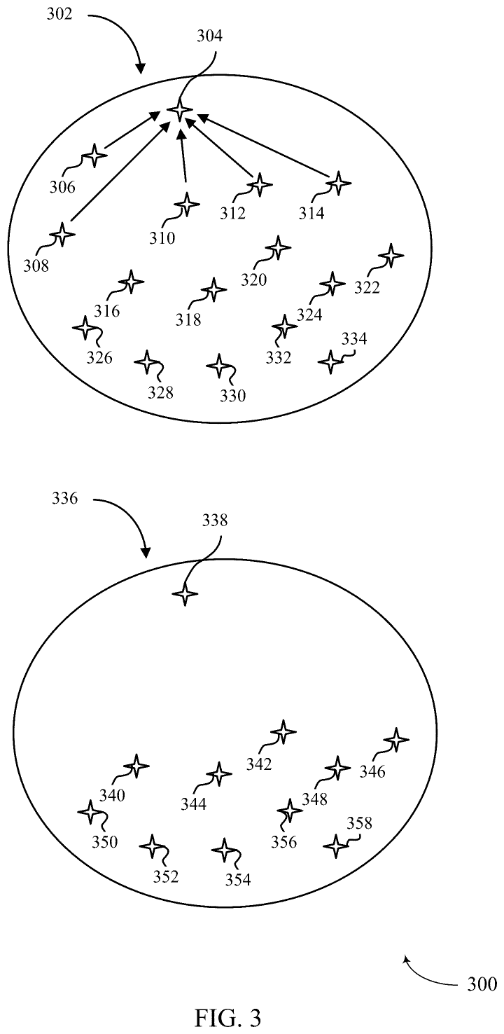

FIG. 3 shows an example of a codeword diagram 300 that supports compression based encoding for nonuniform message transmission in accordance with one or more aspects of the present disclosure. Aspects of the codeword diagram 300 may implement, or be implemented by, aspects of wireless communications system 100 and the wireless communications system 200, or any combination thereof.

In some examples, the UE 115-a may compress the message 210 by combining low-probability events into a single codeword (covering codeword) based on a defined threshold (T). The UE 115-a may generate a first candidate codeword that is one of a first set of candidate codewords, and the UE 115-a may select, based on the first candidate codeword, a first selected codeword from a second set of codewords in a codebook. The second set of codewords includes a representative codeword that maps to more than one of the first set of candidate codewords, and remaining codewords other than the representative codeword of the second set of codewords are each mapped to a respective one of the first set of candidate codewords. The more than one of the first set of candidate codewords map to the representative codeword of the second set of codewords based on each of the more than one of the first set of candidate codewords satisfying the threshold. In some cases, the threshold may be based on a quantity of HARQ-NACK bits in the message.

For example, if ACK probability is greater than NACK probability, messages with greater than the threshold quantity of NACKs may be referred to as low probability events. The messages with the low probability events (e.g., messages that satisfy the threshold) may be mapped to the single codeword (covering codeword), and the other messages (high probability events) may be mapped to codewords and transmitted as is. For example, the uncompressed message may be non-uniform with an ACK (e.g., bit 1) with a 90% probability and NACK (e.g., bit 0) with a 10% probability independent and identically distributed (i.i.d) with K=4 (e.g., 1111, 1110, 1101, 1011, 0111, 0011, 0101, 1001, 0110, 1010, 1100, 0001, 0010, 0100, 1000, 0000). For a threshold of two (e.g., three or more NACKs), the low probability events (e.g., 0000, 1000, 0100, 0010, and 000) may map to the covering codeword (e.g., c(0000)), and the UE 115-a may transmit the covering codeword. The high probability events may be mapped to a respective codeword (e.g., 1111 mapping to c(1111), 1110 mapping to c(1110), 1101 mapping to c(1101), 1011 mapping to c(1011), 0111 mapping to c(0111), 0011 mapping to c(0011), 0101 mapping to c(0101), 0110 mapping to c(0110), 1001 mapping to c(1001), 1010 mapping to c(1010), and 1100 mapping to c(1100)). The UE 115-a may transmit the corresponding codeword c(m) for each m in the high probability set.

Referring to FIG. 3, the codeword diagram 302 illustrates mapping of low probability events into a single codeword. For example, candidate codewords (e.g., candidate codeword 304, candidate codeword 306, candidate codeword 308, candidate codeword 310, candidate codeword 312, and candidate codeword 314) that satisfy the threshold may be mapped to the single codeword (covering codeword). The candidate codewords (e.g., candidate codeword 316, candidate codeword 318, candidate codeword 320, candidate codeword 322, candidate codeword 324, candidate codeword 326, candidate codeword 328, candidate codeword 330, candidate codeword 332, and candidate codeword 334) that do not satisfy the threshold are each mapped to one codeword. The codeword diagram 336 illustrate a covering codeword 338 based on a mapping of candidate codeword 304, candidate codeword 306, candidate codeword 308, candidate codeword 310, candidate codeword 312, and candidate codeword 314. The codeword diagram 336 illustrates a codeword 340 based on a mapping of candidate codeword 316, a codeword 342 based on a mapping of candidate codeword 318, a codeword 344 based on a mapping of candidate codeword 320, a codeword 346 based on a mapping of candidate codeword 322, a codeword 348 based on a mapping of candidate codeword 324, a codeword 350 based on a mapping of candidate codeword 326, a codeword 352 based on a mapping of candidate codeword 328, a codeword 354 based on a mapping of candidate codeword 330, a codeword 356 based on a mapping of candidate codeword 332, and a codeword 358 based on a mapping of candidate codeword 334. The UE 115-a may transmit the codewords (e.g., covering codeword 338, codeword 340, codeword 342, codeword 344, codeword 346, codeword 348, codeword 350, codeword 352, codeword 354, codeword 356, and a codeword 358).

In some examples, when combining the low-probability events into a single codeword (e.g., covering codeword) based on the defined threshold, the encoder may assume that the compressed quantity of bits is the same as the uncompressed quantity of bits (e.g., K). For the illustrated example, the encoder may assume that the message length is four bits. The decoder at the network entity 105-a may know that a subset of codewords are transmitted, and the decoder may use the knowledge of the subset of codewords to improve decoding performance.

In some cases, the UE 115-a may receive, from the network entity 105-a, control signaling 215 that indicates the threshold. The threshold value may depend on the quantity of uncompressed bits transmitted. In some cases, the threshold may be indicated based on a look up table comprising threshold (T) values corresponding to K values where K may represent the actual ACK and NACK bits except dummy bits. In some cases, the UE 115-a may receive the threshold as a ratio of T to K (T/K) that may be configured by RRC signaling.

In some examples, the HARQ-ACK codebook may contain both actual HARQ-ACK bits and some dummy HARQ-ACK bits. The compression procedure of combining low-probability events into a single codeword (covering codeword) based on the defined threshold (T) may handle the case with dummy HARQ-ACK bits. In some examples, the threshold (T) may be based on the actual ACK or NACK bits excluding dummy bits. Since the message length is K bits before and after applying the compression, the compression method may change the set of transmitted codewords but does not change the message length. In a case of misalignment, the UE 115-a and the network entity 105-a may decode from a different set of codewords. For example, the set of codewords assumed by UE 115-a may be A, and set of codewords assumed by network entity may be B. If the UE 115-a transmits a codeword that lies in the intersection of the two sets (e.g., A and B), then the network entity 105-a may still decode correctly. The probability of the event that UE 115-a uses a codeword from A but not from B is small by design (e.g., the probability of having a misaligned codebook is small).

For example, dummy bits may be applied to an example uncompressed message with K=4 denoted as {a,b,c,d}. Assuming that bit c is a true dummy bit from the network entity 105-a perspective (e.g., the network entity 105-a did not transmit anything in slot 3) and the UE 115-a may miss a grant for b, so the UE 115-a may think that both b and c are dummy bits. The UE 115-a may encode as {a,0,0,d} and the network entity may decode as {a,b,0,d}. Assuming the threshold is two (T=2) as the prior example, the codebook of the UE 115-a may contain codewords for a,d={0,1} such that less than or equal to 2 NACKs are transmitted (e.g., {1001}, {1000}, {0001}, {0000}, with {0000} being the low probability events set or covering codeword. The codebook of the network entity 105-a may contain codewords a,b,d={0,1} such that less than or equal to 2 NACKs were transmitted (e.g., {1101}, {1100}, {1001}, {0101}, {1000}, {0100}, {0001}, {0000}). Thus, the codebook of the network entity 105-a includes the codebook of the UE 115-a as a subset.

For another example, assuming the threshold is one (T=1), the codebook of the UE 115-a may contain codewords for a,d={0,1} such that less than or equal to 1 NACKs are transmitted (e.g., {1001}, {1000}, {0001}, {0000}, with {0000} being the low probability events set or covering codeword. The codebook of the network entity 105-a may contain codewords a,b,d={0,1} such that less than or equal to 1 NACK were transmitted (e.g., {1101}, {1100}, {1001}, {0101}, {0000}). Thus, the codebook of the network entity 105-a includes two of the four codewords from the codebook of the UE 115-a as a subset (e.g., {1001} and {0000}).

In some cases, a transmit power of a physical uplink control channel (PUCCH) containing uplink control information (UCI) may be calculated based on the quantity of actual information bits to be transmitted. With the lossy compression scheme, the power control formula may be modified using the quantity of uncompressed bits in the power control equation. The transmit power from the UE 115-a for PUCCH may be determined as P_{PUCCH} min{P_{C,max}, P₀(j)+PL(q)+10 log₁₀(2^{μ}M_{RB})+Δ_{F}+Δ_{TF}+g(l)} where P_{C,max} is a maximum transmit power, P₀(j) is an open loop power control parameter (indicated intended receive power at the network entity 105-b), PL(q) indicates the path-loss measured by downlink reference signals, q is a path-loss index useful for beam-based power control, M_{RB} is a quantity of resource blocks (RBs) of the PUCCH transmission (e.g., bandwidth), Δ_{F} is an RRC configured parameter specific for a PUCCH format, g(l) is a closed-loop power control, and Δ_{TF} is a delta power based on the spectral efficiency of PUCCH. For Δ_{TF}, Δ_{TF}10 log₁₀((2^{BPRE·K}^{₂}−1)) when total quantity of UCI bits>11, where K₂=2.4, Δ_{TF}=10 log₁₀(BPRE·K₁) when total quantity UCI bits<11, and

$$BPRE = \frac{\# UCI including CRC bits}{{N}_{R E}}$$

stands for the rate (spectral efficiency) of the PUCCH transmission, and N_{RE} denotes the quantity of REs used to transmit the UCI.

For the lossy compression scheme, the power control formula parameters of interest that control the power of PUCCH are P₀ and Δ_{TF}. For the nonuniform message, BPRE may be modified based on the quantity of transmitted codewords as follows to incorporate the entropy of the message bits

$$B P R E = \frac{{log}_{2} ( \#transmitted codewords ) + ( n\_SR + n\_CSI + o\_CRC )}{{N}_{R E}} .$$

The quantity of transmitted codewords may be calculated using the defined threshold value (T). For example, with the ACK probability greater than the NACK probability, K=4 and T=2, the quantity of transmitted codewords may be

$$\#transmitted codewords = ( \# sequences with \leq T NACKS ) + 1 = ( \begin{matrix}4 \\ 0\end{matrix} ) + ( \begin{matrix}4 \\ 1\end{matrix} ) + ( \begin{matrix}4 \\ 2\end{matrix} ) + 1 = 12.$$

In some examples, other UCI, such as channel state information (CSI) or scheduling requests (SR), may be multiplexed and jointly encoded with HARQ-ACK bits. The other UCI may not be compressed. The HARQ-ACK bits may be compressed by counting the quantity of NACKs and compressing the event where the quantity of NACKs is greater than the threshold (T). For the power control, the BPRE may be computed based on the quantity of other UCI plus the effective information size of the HARQ-ACK. For example, 1 bit SR and 4 bits HARQ-ACK may be multiplexed. For the example T=2, the information vector may be SR+HARQ-ACK with and SR={0,1} and low probability HARQ-ACK={1000, 0010, 0001, 0100, 0000} being mapped to c{SR,0000}. In this case, there may be two covering codewords (e.g., one covering codeword for SR=0, one covering codeword for SR=1). For other examples, the quantity of covering codewords may generalize to the arbitrary quantity of non-HARQ-ACK bits.

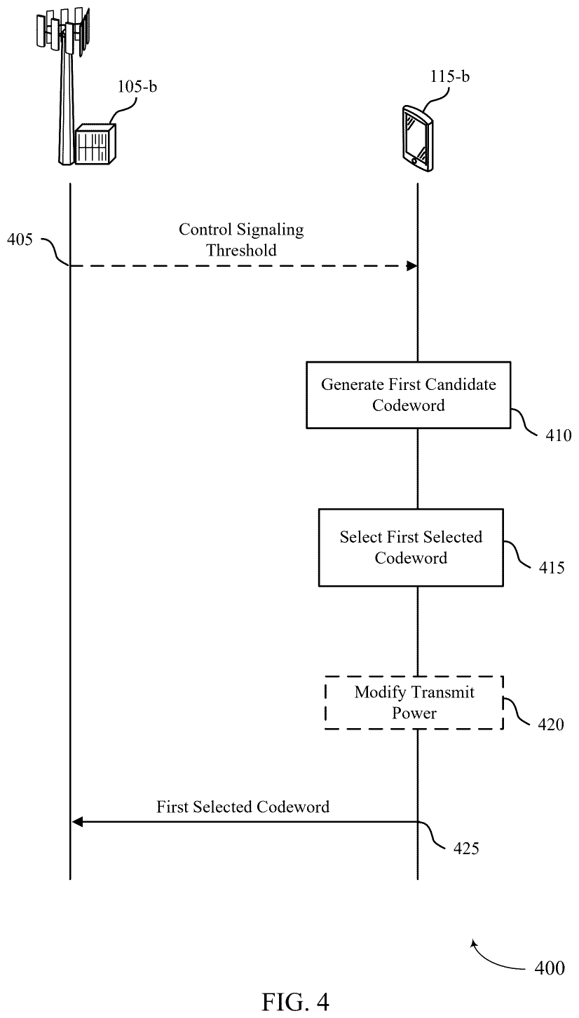

FIG. 4 shows an example of a process flow 400 that supports compression based encoding for nonuniform message transmission in accordance with one or more aspects of the present disclosure. In some examples, the process flow 400 may implement or be implemented by aspects of the wireless communications systems 100 and 200 as described with reference to FIGS. 1 and 2, respectively. For example, the process flow 400 may be implemented by a network entity 105-b, which may be an example of the network entities 105 as described with reference to FIGS. 1 and 2. The process flow 400 may be implemented by a UE 115-b, which may be an example of the UEs as described with reference to FIGS. 1 and 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, optionally, the UE 115-b may receive control signaling that indicates a threshold.

At 410, the UE 115-b may generate a first candidate codeword that is one of a first set of candidate codewords. In some cases, the threshold may be associated with a codeword length of each of the first set of candidate codewords. In some cases, a probability of generation of individual ones of the first set of candidate codewords may be non-uniform.

At 415, the UE 115 b may select, based on the first candidate codeword, a first selected codeword from a second set of codewords in a codebook. The second set of codewords may include a representative codeword that maps to more than one of the first set of candidate codewords, and remaining codewords other than the representative codeword of the second set of codewords may be each mapped to a respective one of the first set of candidate codewords. In some cases, the more than one of the first set of candidate codewords map to the representative codeword of the second set of codewords based on each of the more than one of the first set of candidate codewords satisfying the threshold. In some cases, the threshold may be a quantity of HARQ NACK bit values, and the first set of candidate codewords may each represent a unique combination of HARQ bit values. In some cases, the threshold may be a quantity of zero bit values, and the first set of candidate codewords may each represent a unique combination of bit values. In some cases, satisfaction of the threshold may not be based on dummy bits included in any of the first set of candidate codewords. In some cases, each of the second set of codewords may include a same quantity of bits as each of the first set of candidate codewords. In some cases, the more than one of the first set of candidate codewords that map to the representative codeword may have respective first probabilities of generation that are less than second probabilities of generation that correspond to the respective ones of the first set of candidate codewords that map to the remaining codewords. In some cases, the second set of codewords may be a subset of the first set of candidate codewords.

At 420, the UE 115-b may modify a transmit power based at least in part on a first quantity of codewords in the second set of codewords, and the first quantity of codewords may be based at least in part on a second quantity of the more than one of the first set of candidate codewords that satisfy a threshold.

At 425, the UE 115-b may transmit the first selected codeword. In some cases, the UE 115-b may transmit the first selected codeword based at least in part on the modified transmit power.

In some cases, the UE 115-b may multiplex the first selected codeword with non-compressed uplink control information, and the UE 115-b may transmit the multiplexed first selected codeword. In some cases, the UE 115-b may modify a transmit power based at least in part on a first quantity of non-compressed uplink control information codewords and a second quantity of codewords in the second set of codewords, and the second quantity of codewords may be based at least in part on a third quantity of the more than one of the first set of candidate codewords that satisfy a threshold. The UE may transmit the multiplexed first selected codeword based at least in part on the modified transmit power.

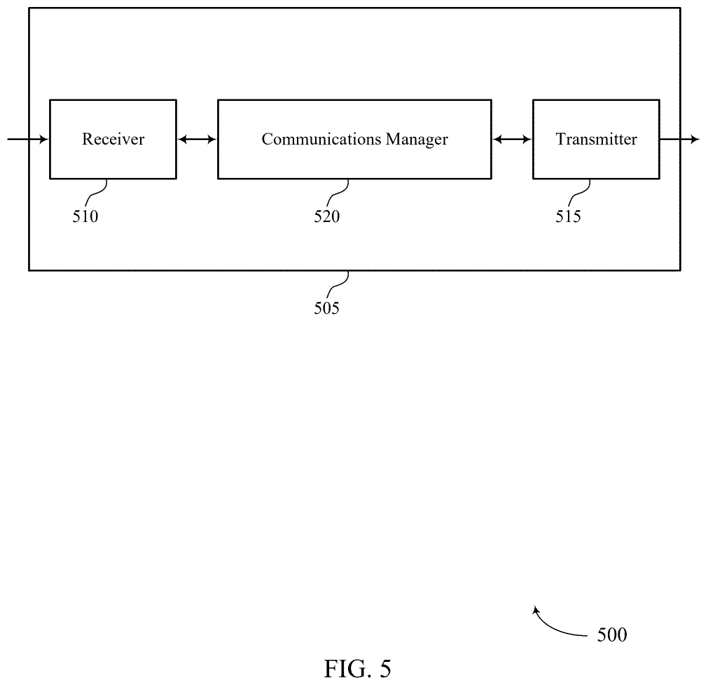

FIG. 5 shows a block diagram 500 of a device 505 that supports compression based encoding for nonuniform message transmission in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to compression based encoding for nonuniform message transmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to compression based encoding for nonuniform message transmission). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of compression based encoding for nonuniform message transmission as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for generating a first candidate codeword that is one of a first set of candidate codewords. The communications manager 520 is capable of, configured to, or operable to support a means for selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords. The communications manager 520 is capable of, configured to, or operable to support a means for transmitting the first selected codeword.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

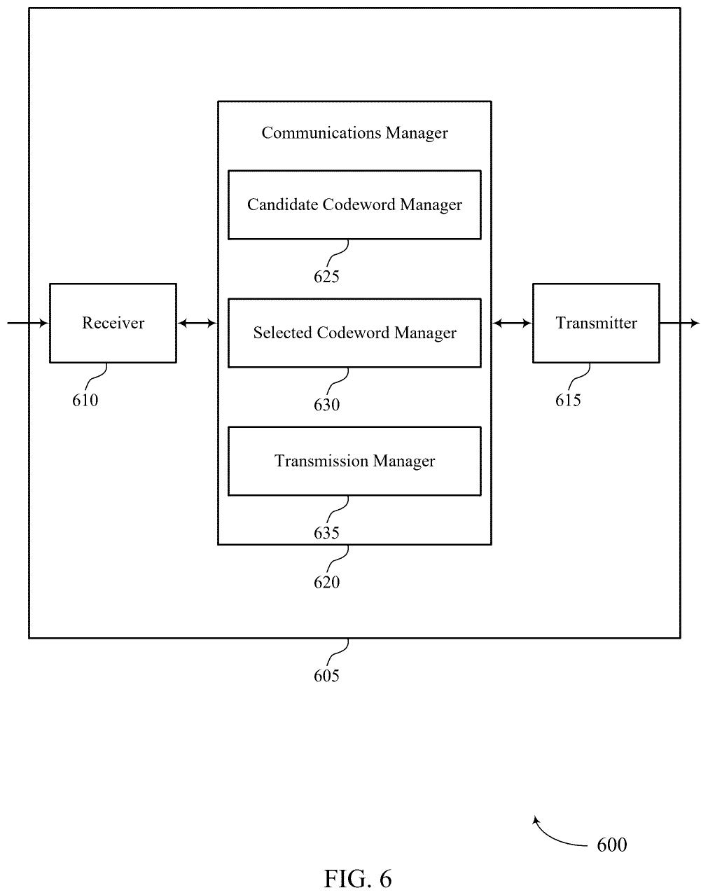

FIG. 6 shows a block diagram 600 of a device 605 that supports compression based encoding for nonuniform message transmission in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to compression based encoding for nonuniform message transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to compression based encoding for nonuniform message transmission). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of compression based encoding for nonuniform message transmission as described herein. For example, the communications manager 620 may include a candidate codeword manager 625, a selected codeword manager 630, a transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The candidate codeword manager 625 is capable of, configured to, or operable to support a means for generating a first candidate codeword that is one of a first set of candidate codewords. The selected codeword manager 630 is capable of, configured to, or operable to support a means for selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords. The transmission manager 635 is capable of, configured to, or operable to support a means for transmitting the first selected codeword.

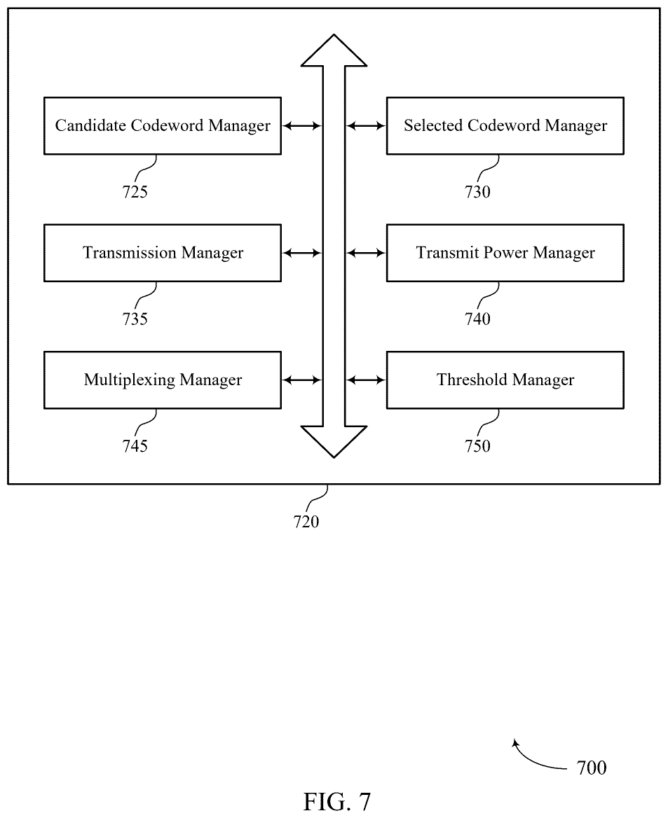

FIG. 7 shows a block diagram 700 of a communications manager 720 that supports compression based encoding for nonuniform message transmission in accordance with one or more aspects of the present disclosure. The communications manager 720 may be an example of aspects of a communications manager 520, a communications manager 620, or both, as described herein. The communications manager 720, or various components thereof, may be an example of means for performing various aspects of compression based encoding for nonuniform message transmission as described herein. For example, the communications manager 720 may include a candidate codeword manager 725, a selected codeword manager 730, a transmission manager 735, a transmit power manager 740, a multiplexing manager 745, a threshold manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The candidate codeword manager 725 is capable of, configured to, or operable to support a means for generating a first candidate codeword that is one of a first set of candidate codewords. The selected codeword manager 730 is capable of, configured to, or operable to support a means for selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords. The transmission manager 735 is capable of, configured to, or operable to support a means for transmitting the first selected codeword.

In some examples, the more than one of the first set of candidate codewords map to the representative codeword of the second set of codewords based on each of the more than one of the first set of candidate codewords satisfying a threshold.

In some examples, the threshold is a quantity of HARQ NACK bit values. In some examples, the first set of candidate codewords each represent a unique combination of HARQ bit values.

In some examples, the threshold is a quantity of zero bit values. In some examples, the first set of candidate codewords each represent a unique combination of bit values.

In some examples, satisfaction of the threshold is not based on dummy bits included in any of the first set of candidate codewords.

In some examples, the threshold is associated with a codeword length of each of the first set of candidate codewords.

In some examples, the threshold manager 750 is capable of, configured to, or operable to support a means for receiving control signaling that indicates the threshold.

In some examples, each of the second set of codewords corresponds to a same quantity of message bits as each of the first set of candidate codewords.

In some examples, a probability of generation of individual ones of the first set of candidate codewords is non-uniform.

In some examples, the more than one of the first set of candidate codewords that map to the representative codeword have respective first probabilities of generation that are less than second probabilities of generation that correspond to the respective ones of the first set of candidate codewords that map to the remaining codewords.

In some examples, the second set of codewords is a subset of the first set of candidate codewords.

In some examples, to support transmitting the first selected codeword, the transmit power manager 740 is capable of, configured to, or operable to support a means for modifying a transmit power based on a first quantity of codewords in the second set of codewords, where the first quantity of codewords is based on a second quantity of the more than one of the first set of candidate codewords that satisfy a threshold. In some examples, to support transmitting the first selected codeword, the transmission manager 735 is capable of, configured to, or operable to support a means for transmitting the first selected codeword based on the modified transmit power.

In some examples, to support transmitting the first selected codeword, the multiplexing manager 745 is capable of, configured to, or operable to support a means for multiplexing the first selected codeword with non-compressed uplink control information. In some examples, to support transmitting the first selected codeword, the transmission manager 735 is capable of, configured to, or operable to support a means for transmitting the multiplexed first selected codeword.

In some examples, to support transmitting the multiplexed first selected codeword, the transmit power manager 740 is capable of, configured to, or operable to support a means for modifying a transmit power based on a first quantity of non-compressed uplink control information codewords and a second quantity of codewords in the second set of codewords, where the second quantity of codewords is based on a third quantity of the more than one of the first set of candidate codewords that satisfy a threshold. In some examples, to support transmitting the multiplexed first selected codeword, the transmission manager 735 is capable of, configured to, or operable to support a means for transmitting the multiplexed first selected codeword based on the modified transmit power.

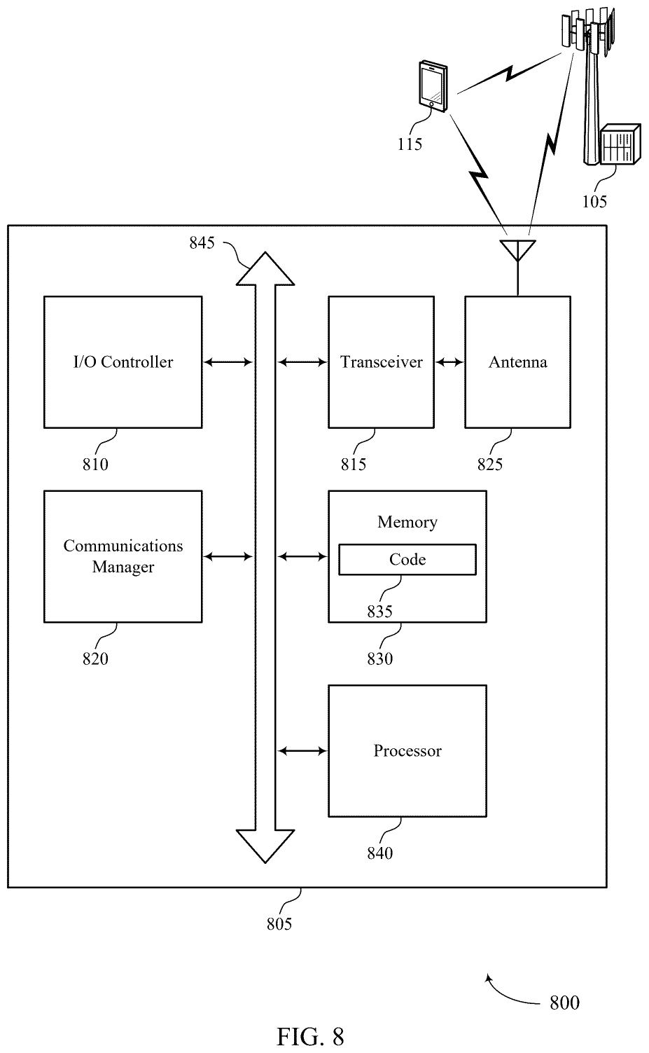

FIG. 8 shows a diagram of a system 800 including a device 805 that supports compression based encoding for nonuniform message transmission in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting compression based encoding for nonuniform message transmission). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for generating a first candidate codeword that is one of a first set of candidate codewords. The communications manager 820 is capable of, configured to, or operable to support a means for selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords. The communications manager 820 is capable of, configured to, or operable to support a means for transmitting the first selected codeword.

By including or configuring the communications manager 820 in accordance with examples as described herein, the device 805 may support techniques for more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of compression based encoding for nonuniform message transmission as described herein, or the at least one processor 840 and the at least one memory 830 may be otherwise configured to, individually or collectively, perform or support such operations.

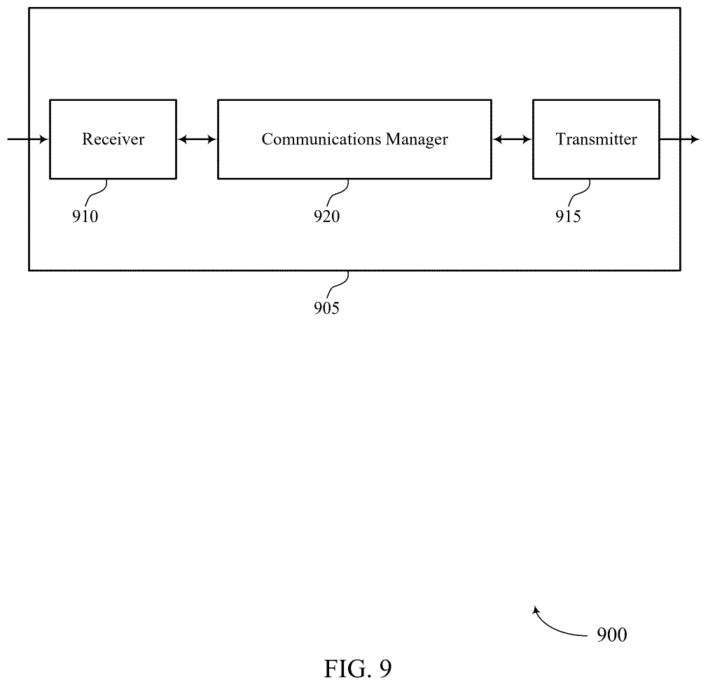

FIG. 9 shows a block diagram 900 of a device 905 that supports compression based encoding for nonuniform message transmission in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of compression based encoding for nonuniform message transmission as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, control signaling that indicates a threshold. The communications manager 920 is capable of, configured to, or operable to support a means for obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

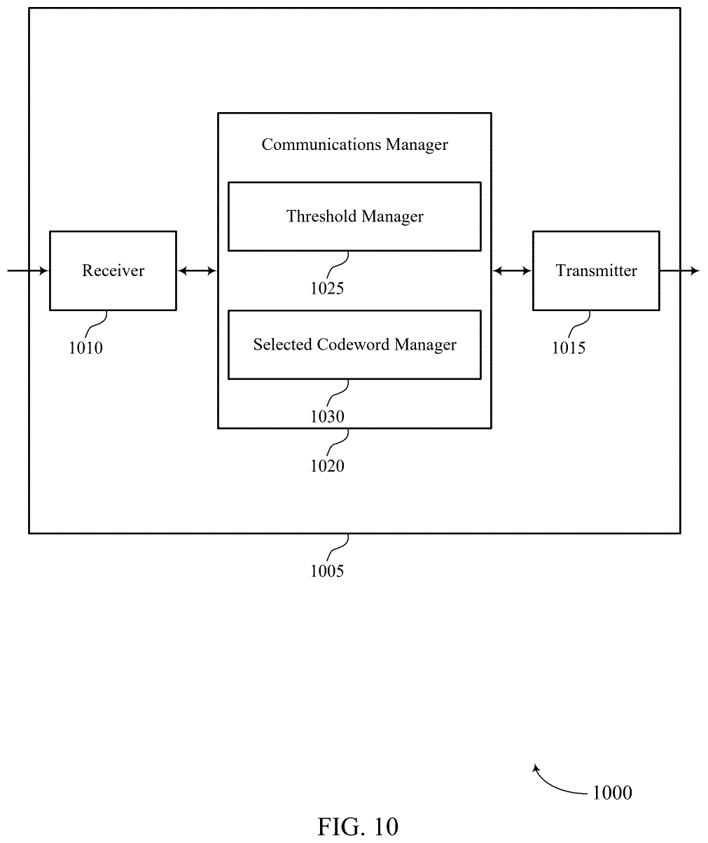

FIG. 10 shows a block diagram 1000 of a device 1005 that supports compression based encoding for nonuniform message transmission in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of compression based encoding for nonuniform message transmission as described herein. For example, the communications manager 1020 may include a threshold manager 1025 a selected codeword manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The threshold manager 1025 is capable of, configured to, or operable to support a means for outputting, to a UE, control signaling that indicates a threshold. The selected codeword manager 1030 is capable of, configured to, or operable to support a means for obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

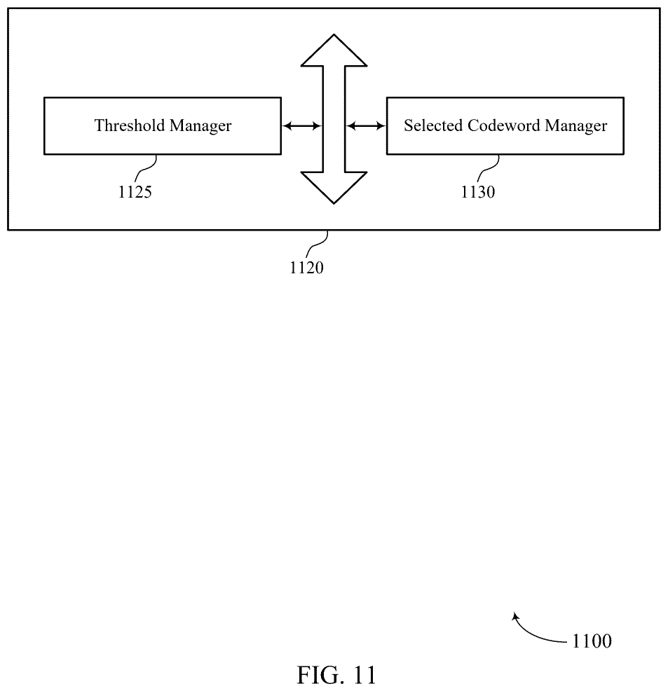

FIG. 11 shows a block diagram 1100 of a communications manager 1120 that supports compression based encoding for nonuniform message transmission in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of compression based encoding for nonuniform message transmission as described herein. For example, the communications manager 1120 may include a threshold manager 1125 a selected codeword manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The threshold manager 1125 is capable of, configured to, or operable to support a means for outputting, to a UE, control signaling that indicates a threshold. The selected codeword manager 1130 is capable of, configured to, or operable to support a means for obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

In some examples, the threshold is a quantity of HARQ NACK bit values. In some examples, the first set of candidate codewords each represent a unique combination of HARQ bit values.

In some examples, the threshold is a quantity of zero bit values. In some examples, the first set of candidate codewords each represent a unique combination of bit values.

In some examples, satisfaction of the threshold is not based on dummy bits included in any of the first set of candidate codewords.

In some examples, the threshold is associated with a codeword length of each of the first set of candidate codewords.

In some examples, each of the second set of codewords corresponds to a same quantity of message bits as each of the first set of candidate codewords.

In some examples, a probability of generation of individual ones of the first set of candidate codewords is a non-uniform.

In some examples, the more than one of the first set of candidate codewords that map to the representative codeword have respective first probabilities of generation that are less than second probabilities of generation that correspond to the respective ones of the first set of candidate codewords that map to the remaining codewords.

In some examples, the second set of codewords is a subset of the first set of candidate codewords.

In some examples, the first selected codeword is multiplexed with non-compressed uplink control information.

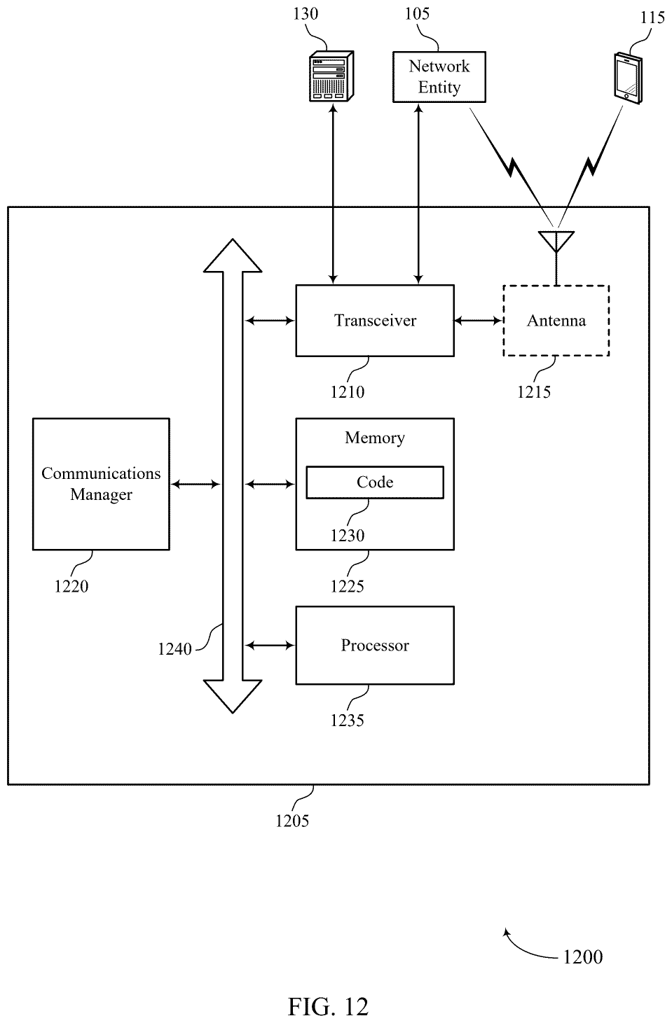

FIG. 12 shows a diagram of a system 1200 including a device 1205 that supports compression based encoding for nonuniform message transmission in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting compression based encoding for nonuniform message transmission). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, control signaling that indicates a threshold. The communications manager 1220 is capable of, configured to, or operable to support a means for obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold.

By including or configuring the communications manager 1220 in accordance with examples as described herein, the device 1205 may support techniques for more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of compression based encoding for nonuniform message transmission as described herein, or the at least one processor 1235 and the at least one memory 1225 may be otherwise configured to, individually or collectively, perform or support such operations.

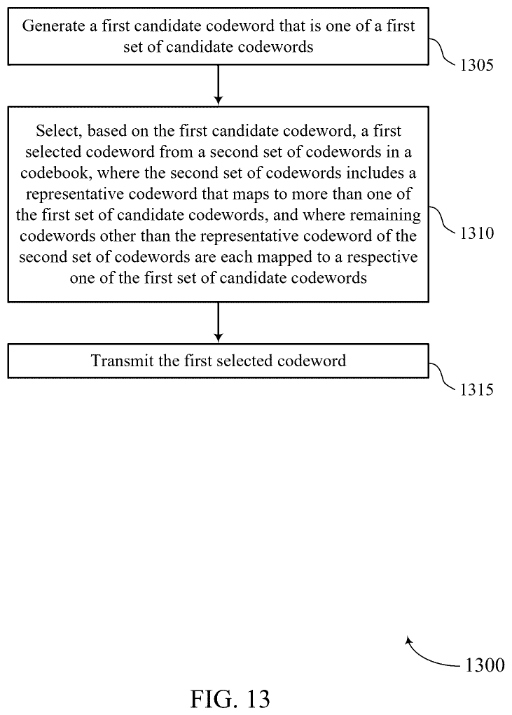

FIG. 13 shows a flowchart illustrating a method 1300 that supports compression based encoding for nonuniform message transmission in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include generating a first candidate codeword that is one of a first set of candidate codewords. The operations of 1305 may be performed in accordance with examples as disclosed herein. In some examples, aspects of the operations of 1305 may be performed by a candidate codeword manager 725 as described with reference to FIG. 7.

At 1310, the method may include selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords. The operations of 1310 may be performed in accordance with examples as disclosed herein. In some examples, aspects of the operations of 1310 may be performed by a selected codeword manager 730 as described with reference to FIG. 7.

At 1315, the method may include transmitting the first selected codeword. The operations of 1315 may be performed in accordance with examples as disclosed herein. In some examples, aspects of the operations of 1315 may be performed by a transmission manager 735 as described with reference to FIG. 7.

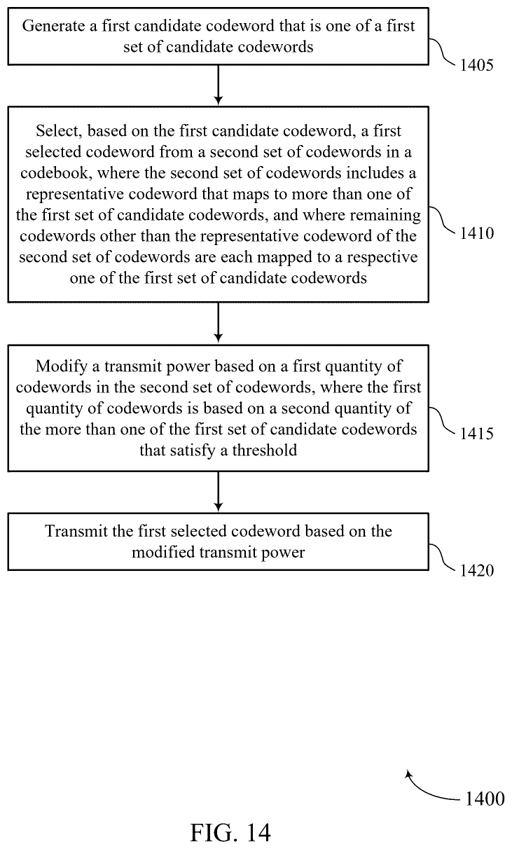

FIG. 14 shows a flowchart illustrating a method 1400 that supports compression based encoding for nonuniform message transmission in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include generating a first candidate codeword that is one of a first set of candidate codewords. The operations of 1405 may be performed in accordance with examples as disclosed herein. In some examples, aspects of the operations of 1405 may be performed by a candidate codeword manager 725 as described with reference to FIG. 7.

At 1410, the method may include selecting, based on the first candidate codeword, a first selected codeword from a second set of codewords in a codebook, where the second set of codewords includes a representative codeword that maps to more than one of the first set of candidate codewords, and where remaining codewords other than the representative codeword of the second set of codewords are each mapped to a respective one of the first set of candidate codewords. The operations of 1410 may be performed in accordance with examples as disclosed herein. In some examples, aspects of the operations of 1410 may be performed by a selected codeword manager 730 as described with reference to FIG. 7.

At 1415, the method may include modifying a transmit power based on a first quantity of codewords in the second set of codewords, where the first quantity of codewords is based on a second quantity of the more than one of the first set of candidate codewords that satisfy a threshold. The operations of 1415 may be performed in accordance with examples as disclosed herein. In some examples, aspects of the operations of 1415 may be performed by a transmit power manager 740 as described with reference to FIG. 7.

At 1420, the method may include transmitting the first selected codeword based on the modified transmit power. The operations of 1420 may be performed in accordance with examples as disclosed herein. In some examples, aspects of the operations of 1420 may be performed by a transmission manager 735 as described with reference to FIG. 7.

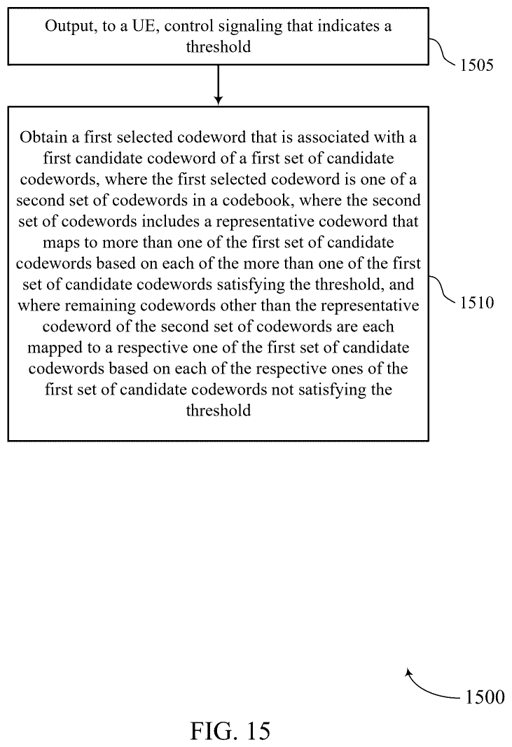

FIG. 15 shows a flowchart illustrating a method 1500 that supports compression based encoding for nonuniform message transmission in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, control signaling that indicates a threshold. The operations of 1505 may be performed in accordance with examples as disclosed herein. In some examples, aspects of the operations of 1505 may be performed by a threshold manager 1125 as described with reference to FIG. 11.

At 1510, the method may include obtaining a first selected codeword that is associated with a first candidate codeword of a first set of candidate codewords, where the first selected codeword is one of a second set of codewords in a codebook, where the second set of codewords includes a representative codeword that maps to more than one of the first set of candidate codewords based on each of the more than one of the first set of candidate codewords satisfying the threshold, and where remaining codewords other than the representative codeword of the second set of codewords are each mapped to a respective one of the first set of candidate codewords based on each of the respective ones of the first set of candidate codewords not satisfying the threshold. The operations of 1510 may be performed in accordance with examples as disclosed herein. In some examples, aspects of the operations of 1510 may be performed by a selected codeword manager 1130 as described with reference to FIG. 11.

The following provides an overview of aspects of the present disclosure:

Aspect 1: A method for wireless communications by a UE, comprising: generating a first candidate codeword that is one of a first set of candidate codewords; selecting, based on the first candidate codeword, a first selected codeword from a second set of codewords in a codebook, wherein the second set of codewords includes a representative codeword that maps to more than one of the first set of candidate codewords, and wherein remaining codewords other than the representative codeword of the second set of codewords are each mapped to a respective one of the first set of candidate codewords; and transmitting the first selected codeword.

Aspect 2: The method of aspect 1, wherein the more than one of the first set of candidate codewords map to the representative codeword of the second set of codewords based on each of the more than one of the first set of candidate codewords satisfying a threshold.

Aspect 3: The method of aspect 2, wherein the threshold is a quantity of HARQ NACK bit values, and the first set of candidate codewords each represent a unique combination of HARQ bit values.

Aspect 4: The method of any of aspects 2 through 3, wherein the threshold is a quantity of zero bit values, and the first set of candidate codewords each represent a unique combination of bit values.

Aspect 5: The method of aspect 4, wherein satisfaction of the threshold is not based on dummy bits included in any of the first set of candidate codewords.

Aspect 6: The method of any of aspects 2 through 5, wherein the threshold is associated with a codeword length of each of the first set of candidate codewords.

Aspect 7: The method of any of aspects 2 through 6, further comprising: receiving control signaling that indicates the threshold.

Aspect 8: The method of any of aspects 1 through 7, wherein each of the second set of codewords corresponds to a same quantity of message bits as each of the first set of candidate codewords.

Aspect 9: The method of any of aspects 1 through 8, wherein a probability of generation of individual ones of the first set of candidate codewords is non-uniform.

Aspect 10: The method of aspect 9, wherein the more than one of the first set of candidate codewords that map to the representative codeword have respective first probabilities of generation that are less than second probabilities of generation that correspond to the respective ones of the first set of candidate codewords that map to the remaining codewords.

Aspect 11: The method of any of aspects 1 through 10, wherein the second set of codewords is a subset of the first set of candidate codewords.

Aspect 12: The method of any of aspects 1 through 11, wherein transmitting the first selected codeword further comprises: modifying a transmit power based at least in part on a first quantity of codewords in the second set of codewords, wherein the first quantity of codewords is based at least in part on a second quantity of the more than one of the first set of candidate codewords that satisfy a threshold; and transmitting the first selected codeword based at least in part on the modified transmit power.

Aspect 13: The method of any of aspects 1 through 12, wherein transmitting the first selected codeword further comprises: multiplexing the first selected codeword with non-compressed uplink control information; and transmitting the multiplexed first selected codeword.

Aspect 14: The method of aspect 13, wherein transmitting the multiplexed first selected codeword further comprises: modifying a transmit power based at least in part on a first quantity of non-compressed uplink control information codewords and a second quantity of codewords in the second set of codewords, wherein the second quantity of codewords is based at least in part on a third quantity of the more than one of the first set of candidate codewords that satisfy a threshold; and transmitting the multiplexed first selected codeword based at least in part on the modified transmit power.

Aspect 15: A method for wireless communications by a network entity, comprising: outputting, to a UE, control signaling that indicates a threshold; and obtaining a first selected codeword that is associated with a first candidate codeword of a first set of candidate codewords, wherein the first selected codeword is one of a second set of codewords in a codebook, wherein the second set of codewords includes a representative codeword that maps to more than one of the first set of candidate codewords based on each of the more than one of the first set of candidate codewords satisfying the threshold, and wherein remaining codewords other than the representative codeword of the second set of codewords are each mapped to a respective one of the first set of candidate codewords based on each of the respective ones of the first set of candidate codewords not satisfying the threshold.

Aspect 16: The method of aspect 15, wherein the threshold is a quantity of HARQ NACK bit values, and the first set of candidate codewords each represent a unique combination of HARQ bit values.

Aspect 17: The method of any of aspects 15 through 16, wherein the threshold is a quantity of zero bit values, and the first set of candidate codewords each represent a unique combination of bit values.

Aspect 18: The method of any of aspects 15 through 17, wherein satisfaction of the threshold is not based on dummy bits included in any of the first set of candidate codewords.

Aspect 19: The method of any of aspects 15 through 18, wherein the threshold is associated with a codeword length of each of the first set of candidate codewords.

Aspect 20: The method of any of aspects 15 through 19, wherein each of the second set of codewords corresponds to a same quantity of message bits as each of the first set of candidate codewords.

Aspect 21: The method of any of aspects 15 through 20, wherein a probability of generation of individual ones of the first set of candidate codewords is a non-uniform.

Aspect 22: The method of aspect 21, wherein the more than one of the first set of candidate codewords that map to the representative codeword have respective first probabilities of generation that are less than second probabilities of generation that correspond to the respective ones of the first set of candidate codewords that map to the remaining codewords.

Aspect 23: The method of any of aspects 15 through 22, wherein the second set of codewords is a subset of the first set of candidate codewords.

Aspect 24: The method of any of aspects 15 through 23, wherein the first selected codeword is multiplexed with non-compressed uplink control information.

Aspect 25: A UE for wireless communications, comprising one or more memories storing processor-executable code, and one or more processors coupled with the one or more memories and individually or collectively operable to execute the code to cause the UE to perform a method of any of aspects 1 through 14.

Aspect 26: A UE for wireless communications, comprising at least one means for performing a method of any of aspects 1 through 14.

Aspect 27: A non-transitory computer-readable medium storing code for wireless communications, the code comprising instructions executable by one or more processors to perform a method of any of aspects 1 through 14.

Aspect 28: A network entity for wireless communications, comprising one or more memories storing processor-executable code, and one or more processors coupled with the one or more memories and individually or collectively operable to execute the code to cause the network entity to perform a method of any of aspects 15 through 24.

Aspect 29: A network entity for wireless communications, comprising at least one means for performing a method of any of aspects 15 through 24.

Aspect 30: A non-transitory computer-readable medium storing code for wireless communications, the code comprising instructions executable by one or more processors to perform a method of any of aspects 15 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
generate a first candidate codeword that is one of a first set of candidate codewords;
select, based on the first candidate codeword, a first selected codeword from a second set of codewords in a codebook, wherein the second set of codewords includes a representative codeword that maps to more than one of the first set of candidate codewords, and wherein remaining codewords other than the representative codeword of the second set of codewords are each mapped to a respective one of the first set of candidate codewords; and
transmit the first selected codeword.

2. The UE of claim 1, wherein the more than one of the first set of candidate codewords map to the representative codeword of the second set of codewords based on each of the more than one of the first set of candidate codewords satisfying a threshold.

3. The UE of claim 2, wherein:
the threshold is a quantity of hybrid-automatic repeat request (HARQ) negative acknowledgment (NACK) bit values, and
the first set of candidate codewords each represent a unique combination of HARQ bit values.

4. The UE of claim 2, wherein:
the threshold is a quantity of zero bit values, and
the first set of candidate codewords each represent a unique combination of bit values.

5. The UE of claim 4, wherein satisfaction of the threshold is not based on dummy bits included in any of the first set of candidate codewords.

6. The UE of claim 2, wherein the threshold is associated with a codeword length of each of the first set of candidate codewords.

7. The UE of claim 2, wherein the one or more processors are individually or collectively further operable to execute the code to cause the UE to:
receive control signaling that indicates the threshold.

8. The UE of claim 1, wherein each of the second set of codewords corresponds to a same quantity of message bits as each of the first set of candidate codewords.

9. The UE of claim 1, wherein:
a probability of generation of individual ones of the first set of candidate codewords is non-uniform.

10. The UE of claim 9, wherein the more than one of the first set of candidate codewords that map to the representative codeword have respective first probabilities of generation that are less than second probabilities of generation that correspond to the respective ones of the first set of candidate codewords that map to the remaining codewords.

11. The UE of claim 1, wherein the second set of codewords is a subset of the first set of candidate codewords.

12. The UE of claim 1, wherein, to transmit the first selected codeword, the one or more processors are individually or collectively further operable to execute the code to cause the UE to:
modify a transmit power based at least in part on a first quantity of codewords in the second set of codewords, wherein the first quantity of codewords is based at least in part on a second quantity of the more than one of the first set of candidate codewords that satisfy a threshold; and
transmit the first selected codeword based at least in part on the modified transmit power.

13. The UE of claim 1, wherein, to transmit the first selected codeword, the one or more processors are individually or collectively further operable to execute the code to cause the UE to:
multiplex the first selected codeword with non-compressed uplink control information; and
transmit the multiplexed first selected codeword.

14. The UE of claim 13, wherein, to transmit the multiplexed first selected codeword, the one or more processors are individually or collectively further operable to execute the code to cause the UE to:
modify a transmit power based at least in part on a first quantity of non-compressed uplink control information codewords and a second quantity of codewords in the second set of codewords, wherein the second quantity of codewords is based at least in part on a third quantity of the more than one of the first set of candidate codewords that satisfy a threshold; and
transmit the multiplexed first selected codeword based at least in part on the modified transmit power.

15. A network entity, comprising:
one or more memories storing processor-executable code; and
one or more processors coupled with the one or more memories and individually or collectively operable to execute the code to cause the network entity to:
output, to a user equipment (UE), control signaling that indicates a threshold; and
obtain a first selected codeword that is associated with a first candidate codeword of a first set of candidate codewords, wherein the first selected codeword is one of a second set of codewords in a codebook, wherein the second set of codewords includes a representative codeword that maps to more than one of the first set of candidate codewords based on each of the more than one of the first set of candidate codewords satisfying the threshold, and wherein remaining codewords other than the representative codeword of the second set of codewords are each mapped to a respective one of the first set of candidate codewords based on each of the respective ones of the first set of candidate codewords not satisfying the threshold.

16. The network entity of claim 15, wherein:
the threshold is a quantity of hybrid-automatic repeat request (HARQ) negative acknowledgment (NACK) bit values, and
the first set of candidate codewords each represent a unique combination of HARQ bit values.

17. The network entity of claim 15, wherein:
the threshold is a quantity of zero bit values, and
the first set of candidate codewords each represent a unique combination of bit values.

18. The network entity of claim 15, wherein satisfaction of the threshold is not based on dummy bits included in any of the first set of candidate codewords.

19. The network entity of claim 15, wherein the threshold is associated with a codeword length of each of the first set of candidate codewords.

20. The network entity of claim 15, wherein each of the second set of codewords corresponds to a same quantity of message bits as each of the first set of candidate codewords.

21. The network entity of claim 15, wherein a probability of generation of individual ones of the first set of candidate codewords is a non-uniform.

22. The network entity of claim 21, wherein the more than one of the first set of candidate codewords that map to the representative codeword have respective first probabilities of generation that are less than second probabilities of generation that correspond to the respective ones of the first set of candidate codewords that map to the remaining codewords.

23. The network entity of claim 15, wherein the second set of codewords is a subset of the first set of candidate codewords.

24. The network entity of claim 15, wherein:
the first selected codeword is multiplexed with non-compressed uplink control information.

25. A method for wireless communications by a user equipment (UE), comprising:
generating a first candidate codeword that is one of a first set of candidate codewords;
selecting, based on the first candidate codeword, a first selected codeword from a second set of codewords in a codebook, wherein the second set of codewords includes a representative codeword that maps to more than one of the first set of candidate codewords, and wherein remaining codewords other than the representative codeword of the second set of codewords are each mapped to a respective one of the first set of candidate codewords; and
transmitting the first selected codeword.

26. The method of claim 25, wherein the more than one of the first set of candidate codewords map to the representative codeword of the second set of codewords based on each of the more than one of the first set of candidate codewords satisfying a threshold.

27. The method of claim 26, wherein:
the threshold is a quantity of hybrid-automatic repeat request (HARQ) negative acknowledgment (NACK) bit values, and
the first set of candidate codewords each represent a unique combination of HARQ bit values.

28. The method of claim 25, wherein each of the second set of codewords corresponds to a same quantity of message bits as each of the first set of candidate codewords.

29. A method for wireless communications by a network entity, comprising:
outputting, to a user equipment (UE), control signaling that indicates a threshold; and
obtaining a first selected codeword that is associated with a first candidate codeword of a first set of candidate codewords, wherein the first selected codeword is one of a second set of codewords in a codebook, wherein the second set of codewords includes a representative codeword that maps to more than one of the first set of candidate codewords based on each of the more than one of the first set of candidate codewords satisfying the threshold, and wherein remaining codewords other than the representative codeword of the second set of codewords are each mapped to a respective one of the first set of candidate codewords based on each of the respective ones of the first set of candidate codewords not satisfying the threshold.

30. The method of claim 29, wherein:
the threshold is a quantity of hybrid-automatic repeat request (HARQ) negative acknowledgment (NACK) bit values, and
the first set of candidate codewords each represent a unique combination of HARQ bit values.
